(19) United States
(12) Patent Application Publication
(10) Pub. No.: US 2009/0288024 A1
(43) Pub. Date: Nov. 19, 2009

(54) USER INTERFACE APPARATUS, IMAGE FORMING APPARATUS USING THE USER INTERFACE APPARATUS, AND METHOD THEREOF

(75) Inventors: Kwang-soo HA, Seoul (KR); Hye-heon Jung, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si, (KR)

(21) Appl. No.: 12/327,904

(22) Filed: Dec. 4, 2008

(30) Foreign Application Priority Data
May 13, 2008 (KR) 2008-44199

(51) Int. Cl. G06F 3/00

(52) U.S. Cl. 715/762

(57) ABSTRACT

An image forming apparatus provides visual feedback according to a determination of whether an input window is activated. The image forming apparatus includes an input unit which receives input of letters or numbers, and a user interface unit which generates a user interface screen including an input window to display information input through the input unit and changes the size of the input window if the input window is activated. Accordingly, direct and instant visual feedback can be provided.

### CROSS-REFERENCE TO RELATED APPLICATIONS

This application claims priority under 35 U.S.C. §119 (a) from Korean Patent Application No. 10-2008-0044199, filed on May 13, 2008, in the Korean Intellectual Property Office, the disclosure of which is incorporated herein by reference in its entirety.

### BACKGROUND OF THE INVENTION

1. Field of the Invention

The present general inventive concept relates to a user interface apparatus, an image forming apparatus using the user interface apparatus, and a method thereof. More particularly, the present general inventive concept relates to a user interface apparatus which provides visual feedback, an image forming apparatus using the user interface apparatus, and a method thereof.

2. Description of the Related Art

Conventional image forming apparatuses, such as printers, scanners, copiers, facsimile machines, and multifunction peripherals having at least two functions thereof, have been introduced and widely used.

The image forming apparatus performs printing a document after performing an operation using a computer which is connected to an image forming apparatus, copying or scanning a document by manipulating a control panel on an image forming apparatus, and receiving and outputting an externally transmitted facsimile.

The image forming apparatus which receives user inputs needs to visualize the user inputs using a display panel. This is the object of providing user interfaces and is an important issue.

A conventional image forming apparatus having a display panel has a section for displaying predefined input content and displays the input content on the section in a particular method. In such an outputting method of the display panel, a user interface cannot interactively respond to the user input and simply outputs the input in a limited area. Accordingly, the user cannot easily recognize input errors.

In addition, if input information is long and complicated such as a facsimile number or an E-mail address, a readabililty issue may occur frequently so that users having bad eyesight, such as farsightedness due to old age and shortsightedness may have problems with watching it.

That is, in a method for providing an interface of a conventional image forming apparatus, 1) if the user inputs information using keys, a liquid crystal display (LCD) simply provides change of numbers, 2) a readabililty issue may occur to users having farsightedness due to old age and shortsightedness, and 3) when complicated information is input, it is difficult that the user recognizes input errors.

Such problems do not only occur in image forming apparatuses, but also occur in diverse devices which require user inputs and provide the user with feedback. Therefore, there is a demand for user interfaces which interactively respond to user input and takes a variety of users into consider.

### SUMMARY OF THE INVENTION

The present general inventive concept provides a user interface which provides more effective visual feedback when an input window is activated, an image forming apparatus using the user interface, and a method thereof.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing a user interface apparatus which is provided to an image forming apparatus, the user interface apparatus including a user interface (UI) generation unit to generate a UI including an input window, and a control unit to control the UI generation unit to change the size of the input window if the input window is activated.

The control unit may control the UI generation unit to enlarge the size of the input window if a letter or a number starts being input into the input window or if the image forming apparatus enters a mode to require a letter or a number to be input into the input window.

The control unit may control the UI generation unit to change the size of the letter or the number to be input into the input window according to variance in the size of the input window.

The control unit may control the UI generation unit to restore the size of the input window to a default size if a preset event occurs after the letter or the number is input into the input window or if a preset period of time has passes after the letter or the number is input into the input window.

The UI generation unit may generate a plurality of input windows and locate a cursor in at least one of the plurality of input windows, and the control unit may control the UI generation unit to change the size of the input window in which the cursor is located.

The control unit may control the UI generation unit to reduce the size of a first input window and enlarge the size of a second input window if the cursor moves from the first input window to the second input window among the plurality of input windows.

The control unit may change the size of a non-input-window area and a letter or a number in the non-input-window area if the size of the input window changes.

The foregoing and/or other aspects and utilities of the present general inventive concept may be achieved by providing a method for providing a user interface (UI) by an image forming apparatus, the method including generating a UI including an input window, activating the input window, and changing the size of the input window.

The size of the input window may be enlarged if a letter or a number starts being input into the input window or if the image forming apparatus enters a mode to require a letter or a number to be input into the input window.

The size of the letter or the number to be input into the input window may change according to variance in the size of the input window.

The method may further include restoring the size of the input window to a default size if a preset event occurs after the letter or the number is input into the input window or if a preset period of time has passes after the letter or the number is input into the input window.

The method may further include changing the size of a non-input-window area and a letter or a number in the non-input-window area if the size of the input window changes.

The method may further include generating a plurality of input windows and locating a cursor in at least one of the plurality of input windows, and changing the size of the input window in which the cursor is located.

The method may further include reducing the size of a first input window and enlarging the size of a second input window if the cursor moves from the first input window to the second input window among the plurality of input windows.

The foregoing and/or other aspects and utilities of the present general inventive concept may also be achieved by providing a computer-readable medium containing computer-readable codes as a program to perform a user interface usable with an image forming apparatus, the method including generating a UI comprising an input window, activating the input window, and changing the size of the input window.

The foregoing and/or other aspects and utilities of the present general inventive concept may also be achieved by providing an image forming apparatus including a user interface apparatus including a user interface (UI) generation unit to generate a UI comprising an input window, and a control unit to control the UI generation unit to change the size of the input window if the input window is activated to receive data, and a unit to perform an operation corresponding to the received data.

The unit may be one of a printing unit, a copying unit, a scanning unit, and a faxing unit.

The input window may be activated according to a placement of a cursor in the input window.

The size of the input window may be changed with respect to a size of the UI.

The UI may include a plurality of items including an item of the input window, and the plurality of items may be changed according to the change of the input window.

### BRIEF DESCRIPTION OF THE DRAWINGS

These and/or other aspects and utilities of the present general inventive will become apparent and more readily appreciated from the following description of the embodiments, taken in conjunction with the accompanying drawings of which:

FIG. 1 is a schematic block diagram illustrating a configuration of a user interface apparatus according to an exemplary embodiment of the present general inventive concept;

FIGS. 2A and 2B illustrate user interface screens having an input window varying in size to allow a user to input letters or numbers according to an embodiment of the present general inventive concept;

FIGS. 3A to 3C illustrate user interface screens having an input window varying in size to allow a user to enter a mode for inputting letters or numbers according to an embodiment of the present general inventive concept;

FIGS. 4A to 4C illustrate user interface screens having an input window to allow a user to input letters or numbers varying in size according to variance in the size of the input window according to an embodiment of the present general inventive concept;

FIGS. 5A to 5D illustrate user interface screens having a plurality of input windows varying in size according to a user command when the plurality of input windows are generated;

FIGS. 6A to 6C illustrate user interface screens having an input window varying in size according to movement of a cursor in the user interface screen including the plurality of input windows;

FIG. 7 is a schematic block diagram illustrating an image forming apparatus according to an exemplary embodiment of the present general inventive concept;

FIG. 8 is a flow chart illustrating a method of providing a user interface according to an exemplary embodiment of the present general inventive concept; and

FIG. 9 is a flow chart illustrating the method of providing a user interface in FIG. 8 in more detail.

### DETAILED DESCRIPTION OF THE PREFERRED EMBODIMENTS

Reference will now be made in detail to the present embodiments of the present general inventive concept, examples of which are illustrated in the accompanying drawings, wherein like reference numerals refer to like elements throughout. The embodiments are described below in order to explain the present general inventive concept by referring to the figures.

FIG. 1 is a schematic block diagram illustrating a user interface apparatus 100 according to an exemplary embodiment of the present general inventive concept. As illustrated in FIG. 1, the user interface apparatus 100 includes a user interface (UI) generation unit 110 and a control unit 120. The user interface apparatus 100 may further include a display unit 110a to display a user interface screen generated from the UI generation unit 110. The display unit 110a may be installed on a main body of the user interface apparatus 100 in an integrated body, or the display unit 110a may be connected to the main body through a wired or wireless connection to communicate with the UI generation unit 110 such that the UI generation unit 110 generates a signal representing the user interface screen and the display unit 110a displays an image corresponding to the user interface screen.

The UI generation unit 110 generates a user interface screen including one or more input windows. The input window is a window to input letters or numbers and can be generated in diverse forms according a variety of functions provided by an image forming apparatus. The input window may include performing a function corresponding to inputting letters or numbers without inputting letters or numbers, for example, clicking on corresponding windows which is the same function as inputting letters or numbers, or selecting the corresponding windows.

The UI generation unit 110 generates a user interface screen which provides menus for diverse function and messages provided by the image forming apparatus.

The display unit 110a displays a screen, that is, displays the user interface screen including the input window generated by the UI generation unit 110. The display unit 110a may be implemented as a liquid crystal display (LCD), a cathode ray tube (CRT), a plasma display panel (PDP), or organic light emitting diodes (OLED). The display unit 110a may be implemented as a touch screen to enter data by touching a corresponding portion of the touch screen.

If an input window is activated, the control unit 120 controls the UI generation unit 110 to modify the size of the input window. The input window is activated when entering a mode corresponding to the input window, or when starting inputting letters or numbers into the input window. This is merely an exemplary embodiment, and the meaning of “activated” is not limited thereto.

More specifically, the control unit 120 controls the UI generation unit 110 to enlarge the input window when starting inputting letters or numbers into the input window. When starting inputting letters or numbers into the input window may mean when letters or numbers are input directly or when a cursor to input letters or numbers is positioned in the input window.

The control unit 120 controls the UI generation unit 110 to enlarge the input window when entering a mode which asks the user to input letters or numbers into the input window. The mode which asks the user to input letters or numbers into the input window may be a facsimile mode which asks the user to input a facsimile number or a case to input a file name for the search for a file.

The control unit 120 controls the UI generation unit 110 to vary the size of a window when a menu changes, for example, when the user moves from an upper menu to a lower menu.

The control unit 120 controls the UI generation unit 110 to restore an input window to a default size (or a previous size) when preset event occurs after letters or numbers are input into the input window. The preset event may include when a corresponding key is input or when a corresponding operation is completed. When a corresponding operation is completed means, for example, when transmitting a facsimile is completed after a facsimile number is input.

The control unit 120 controls the UI generation unit 110 to restore an input window to a default size (or a previous size) when a preset period of time has passed after letters or numbers are finally input. The preset period of time can be adjusted by the user.

The control unit 120 controls the UI generation unit 110 to restore an input window to a default size (or a previous size) when a preset period of time has passed after the size of the input window changes.

The control unit 120 controls the UI generation unit 110 to change the size of letters or numbers to be input into an input window according to variance in the size of an input window. In this case, a ratio to change the size of letters or numbers to be input according to a variance degree in the size of the input window can be preset. However, the ratio can be adjusted by the user.

The control unit 120 controls the UI generation unit 110 to change the size of a non-input-window area and letters or numbers therein if the size of an input window changes.

The control unit 120 controls the UI generation unit 110 to maintain the size of a non-input-window area and letters or numbers therein and overlap the non-input-window area with an input window if the size of the input window is enlarged.

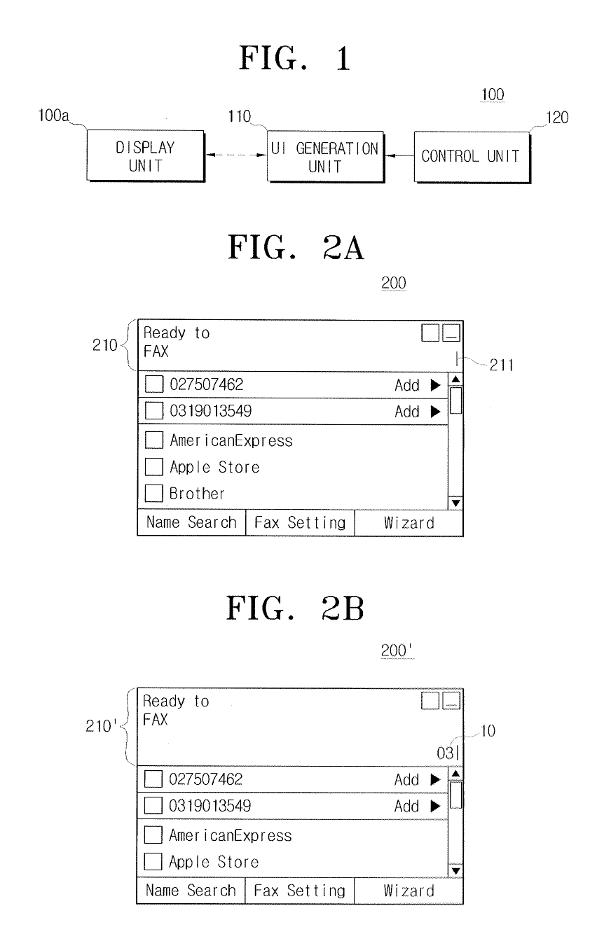

FIGS. 2A and 2B illustrate user interface screens 200 and 200′ having an input window 210 and 210′ varying in size with respect to an area of the user interface window 200 and 200′ to allow a user to input letters or numbers according to an embodiment of the present general inventive concept

When a user command is not input as illustrated in FIG. 2A, an input window 210 maintains its default size, and a cursor 211 to represent the size of letters or numbers to be input maintains its default size.

As illustrated in FIG. 2B, if letters or numbers are input into an input window 210′, the input window 210′ is enlarged with respect to the screen. In this case, the size of the letters or numbers is maintained.

A reference 10 represents letters or numbers input to the input window 210′. The letters or numbers can be input after the input window 210 is enlarged to the input window 210′. That is, when the cursor 211 is placed in the input window 210, the input window is enlarged to the input window 210′, and then, either the letters or numbers 10, alone and in combination, can be input. After the letters or numbers 10 have been input, the input window 210′ can be returned to the input window 210. It is possible that when the input window 210 is enlarged to the input window 210′, at least one of items, for example, the item of “Brother,” displayed in the screen cannot be seen, or the enlarged input window 210′ can overlap another portion of the screen. An area of the input window 210′ is larger than area of the input window 210 with respect to an entire area of the screen such that an area of the cursor 211 is enlarged and then a user can easily locate the cursor area and input the letters and/or numbers 10.

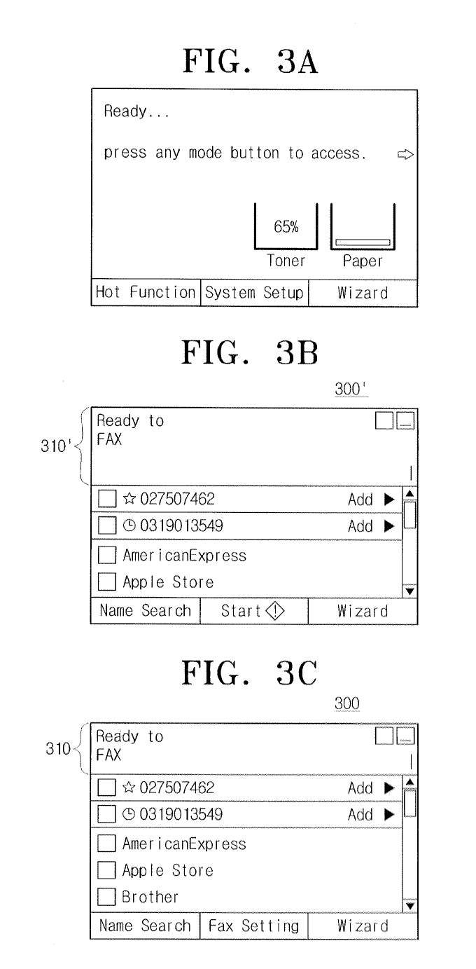

FIGS. 3A to 3C illustrate user interface screens 300, 300′, and 300″ having an input window varying in size to allow a user to input a mode for inputting letters or numbers according to an embodiment of the present general inventive concept.

If a standby mode as illustrated in FIG. 3A changes to a facsimile mode, an input window 310′ is enlarged as illustrated in FIG. 3B.

The mode can be selected by clicking or selecting an arrow or a designated portion to change the mode or direct the screen to the mode. According to an input to change or select the mode, the screen 300 is changed to the screen 300′ with an input window 310′ to allow a user to input data, for example, letters and/or numbers.

If a key is input or a preset period of time has passed after the input window 310′ is enlarged as illustrated in FIG. 3B, the input window 310′ changes to the default size, for example, the input window 310 of the screen 300″ as illustrated in FIG. 3C.

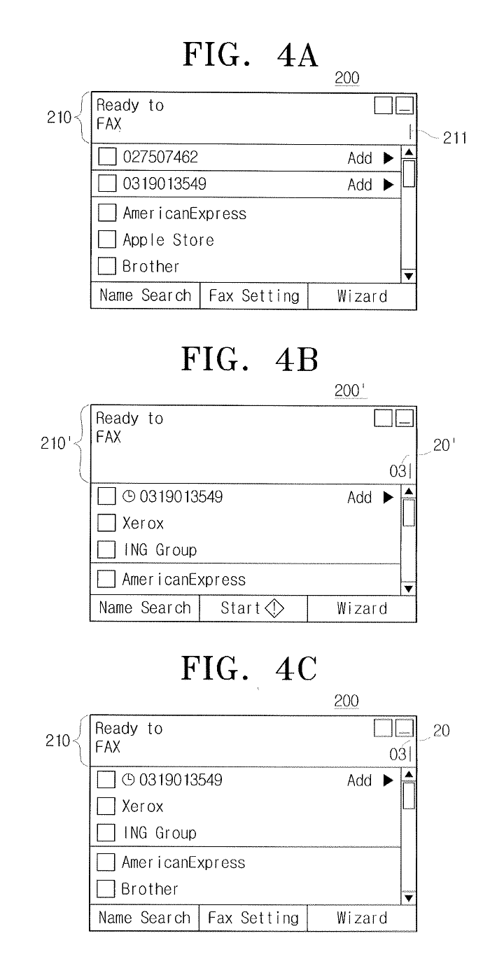

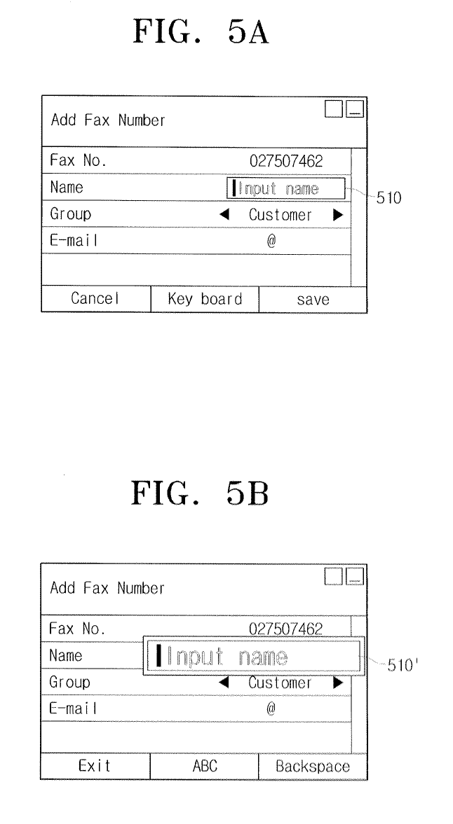

FIGS. 4A to 4C illustrate user interface screens 200 and 200′ having an input window varying in size to allow a user to input letters or numbers according to variance in the size of the input window according to an embodiment of the present general inventive concept.

If letters or numbers are input into an input window 210 of the default size as illustrated in FIG. 4A, the input window 210′ and the letters or numbers are enlarged as illustrated in FIG. 4B.

If a key is input or a preset period of time has passed after the input window 210′ is enlarged as illustrated in FIG. 4B, the input window 210 changes to the default size as illustrated in FIG. 4C. In addition, the input window 210 changes to the default size as illustrated in FIG. 4C after a faxing operation is completed. Concurrently, the enlarged letters or numbers changes to the default size.

The UI generation unit 110 may generate a plurality of input windows and locate a cursor into at least one of the plurality of input windows.

The control unit 120 controls the UI generation unit 110 to change the size of the input window in which the cursor is located among the plurality of input windows.

The control unit 120 controls the UI generation unit 110 to reduce a first input window and enlarge a second window if the cursor moves from the first input window to the second input window among the plurality of input windows.

As illustrated in FIG. 4A, the input window 210 of the screen 200 includes a cursor 211 therein. The input window 210 of FIG. 4A is changed to the input window 210′ of the screen 200′ of FIG. 4B to provide a more space to input at least one of the numbers and letters 20′. It is possible that “Ready to FAX” may not be changed in size. It is also possible that an item of “0319013549,” “Store,” etc., may not be seen in the screen 200′ to provide a space for the enlarged input window 210′. When the numbers and/or letters 20′ are input, the input window 200′ is changed to the input window 210. It is possible that the input numbers and/or letters are not changed in size. However, a characteristic of the input number and/or letters can be changed in color, for example. A predetermined, related, corresponding item can be added to or deleted from the input window 200 and 200′ during, after, before the change of the input window 210 and 210′ in size with respect to the screens 200 and 200′.

As illustrated in FIG. 4B, a space or a height for the cursor area of the cursor 211 is larger than the space or height for the cursor area of cursor 211 of FIG. 4A, so that a user can input the letters and/or letters as data for the selected item of “Ready to FAX”.

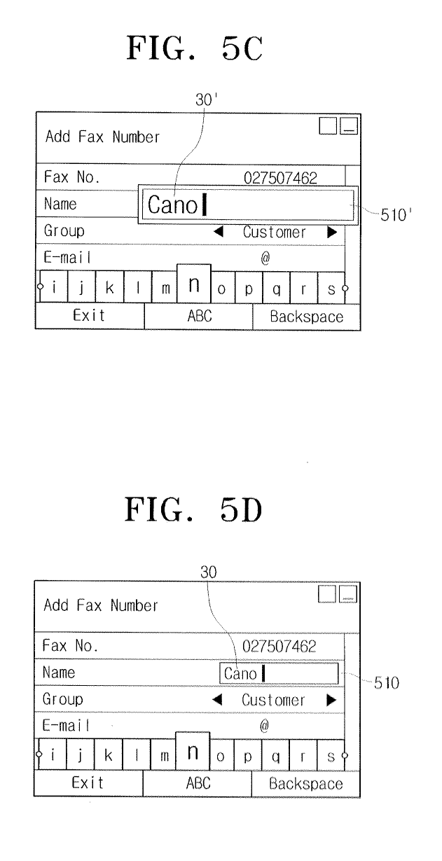

FIGS. 5A to 5D illustrate user interface screens having a plurality of input windows varying in size according to a user command when the plurality of input windows are generated.

FIG. 5A illustrates an input screen to input information into an address book. The input screen includes a plurality of input windows, and the plurality of input windows including a name input window 510 have a default size at first.

If the user moves a cursor to the name input window 510′ in order to input letters as illustrated in FIG. 5B, the name input window 510′ is enlarged. If letters start being input, the letters 30′ are enlarged as illustrated in FIG. 5C.

If a preset period of time has passed after inputting the letters, the name input window 510 and the letters 30 change to the default size as illustrated in FIG. 5D. In addition, the enlarged input window and letters can change to the default size when a corresponding key is input or when a corresponding operation is completed.

In this exemplary embodiment, when an input window is enlarged, the enlarged input window overlaps with the remaining area and so the size of the remaining area is maintained. However, this is merely an exemplary embodiment, and the size of the remaining area and the letters or numbers in the remaining area can change according to the degree of enlarging the input window.

An area 510 of FIG. 5A can be changed to an area 510′ of FIG. 5B such that numbers and/or letters having a large font of FIGS. 5B and 5C can be input to the changed or enlarged area 510′ of FIG. 5B. The input numbers and/or letters having the large font of FIGS. 5B and 5C can be changed to have a smaller font as illustrated in FIG. 5D.

As illustrated in FIGS. 5C and 5D, when an item of “Name” is selected by, for example, placing the cursor 510 in an area of the item of “Name,” a list of alphabets can be displayed, and a selected alphabet can be enlarged to show the selection of the corresponding alphabet and then to be input the input window 510′ and 510.

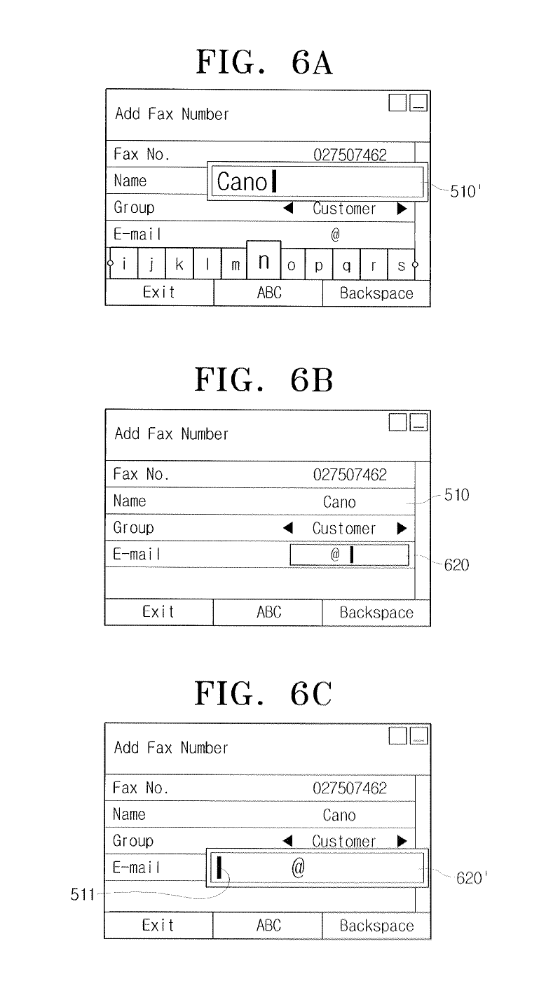

FIGS. 6A to 6C illustrate user interface screens having a plurality of input windows varying in size according to movement of a cursor in an interface screen including the plurality of input windows.

When an input window 510′ is enlarged by inputting letters as illustrated in FIG. 6A, if a cursor to input letters is moved to another input window, the enlarged input window 510′ is reduced as illustrated in FIG. 6B.

As illustrated in FIG. 6C, if a cursor 511 is moved down to an E-mail input window 620′ according to a user command, the E-mail input window 620′ is enlarged.

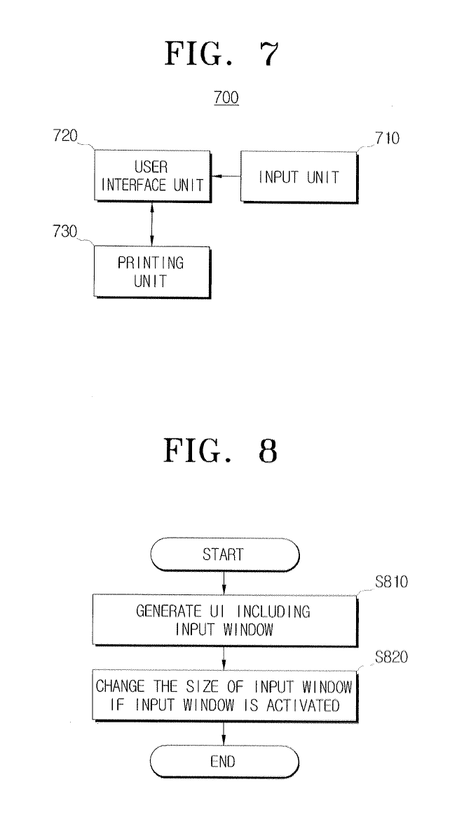

FIG. 7 is a schematic block diagram illustrating an image forming apparatus 700 according to an exemplary embodiment of the present general inventive concept. The image forming apparatus 700 includes an input unit 710 and a user interface unit 720. The image forming apparatus 700 may be a printer, a scanner, a copier, a facsimile machine, and a multifunction peripheral having functions of at least two of the aforementioned devices.

In FIG. 7, the configuration of the image forming apparatus 700 is simply referred and description of a portion which overlaps the configuration and the exemplary embodiments illustrated in FIGS. 1 to 6 is omitted here.

The input unit 710 receives input of letters or numbers. The input unit 710 may include direction keys, a 360° rotating wheel, a jog shuttle, and a jog dial.

The user interface unit 720 generates a user interface screen including an input window to display information input through the input unit 710, and changes the size of the input window if the input window is activated. The user interface unit 720 may have the same configuration as the user interface apparatus 100 of FIG. 1, or may be a separate component with the control unit 120 of FIG. 1.

The user interface unit 720 enlarges an input window when letters or numbers start being input into the input window or when the image forming apparatus 700 enters a mode which requires letters or numbers to be input.

The user interface unit 720 changes the size of letters or numbers to be input into an input window according to variance in the size of the input window.

The user interface unit 720 restores an input window to a default size when preset event occurs after letters or numbers are input into the input window or when a preset period of time has passed after the size of the input window changes.

The user interface unit 720 generates a plurality of input windows, locates a cursor into at least one of the plurality of input windows, and changes the size of the input window in which the cursor is located.

The image forming apparatus 700 may further include a function unit to perform an operation selected through the screen of FIGS. 2A-6C or to perform an operation according to the input numbers and/or letters. The operation may be performed according to at least one of data corresponding to an image to be scanned, printed, faxed, or copied, the selected item, and the input numbers and/or letters on the selected item. For example, the function unit can be a printing unit 730 to form an image on a printing medium according to at least one of printing data corresponding to the image, the selected item, and the input numbers and/or letters. It is possible that the function unit may be a scanning unit, a copying unit, a faxing unit, etc., to be performed in a multi-purpose (multifunctional) device having one or more function as describe above.

In FIG. 7, description of a portion which overlaps the configuration and the exemplary embodiments illustrated in FIGS. 1 to 6 is omitted here.

FIG. 8 is a flow chart illustrating a method of providing a user interface by an image forming apparatus according to an exemplary embodiment of the present general inventive concept.

Referring to FIG. 8, in operation S810, a UI including an input window is generated. In operation S820, if the input window is activated, the size of the input window changes.

The method may further include an operation of performing the above-described functions, such as a printing, copying, scanning, sending a fax, etc., according to the data input through the UI.

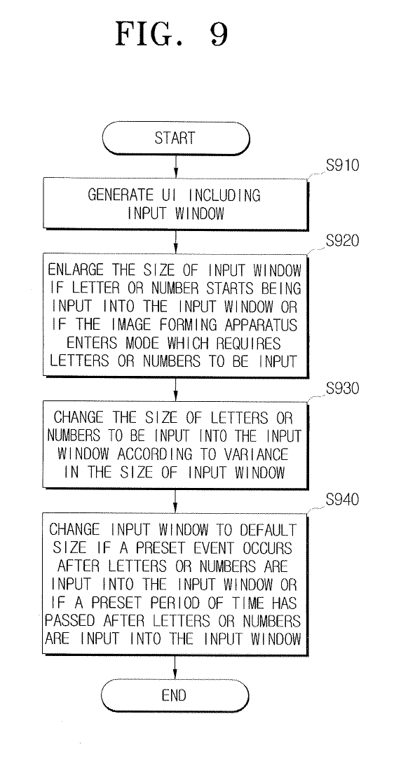

FIG. 9 is a flow chart illustrating the method of providing a user interface by an image forming apparatus in FIG. 8 in more detail.

Referring to FIG. 9, in operation S910, a UI including an input window is generated. In operation S920, if letters or numbers start being input into the input window or if the image forming apparatus enters a mode which requires letters or numbers to be input, the input window is enlarged.

In operation S930, the size of letters or numbers to be input into the input window can change according to variance in the size of the input window.

In operation S940, if a preset event occurs after letters or numbers are input into the input window or if a preset period of time has passed after letters or numbers are input into the input window, the input window changes to the default size.

A plurality of input windows are generated, and a cursor is located into at least one of the plurality of input windows. The size of the input window in which the cursor is located can change.

Among the plurality of input windows, if the cursor moves from a first input window to a second input window, the first input window is reduced and the second window is enlarged.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

As can be appreciated from the above description, when the input window is activated, that is, when the image forming apparatus enters an input mode or when users input letters or numbers in the input window, the letter or numbers are enlarged so as to draw the user's attention. Therefore, users can confirm where feedback of input occurs on a display.

In addition, users can easily be aware of errors of input letters or numbers, and a more recognizable user interface screen can be provided to users in diverse situations.

Although various embodiments of the present general inventive concept have been illustrated and described, it will be appreciated by those skilled in the art that changes may be made in these embodiments without departing from the principles and spirit of the general inventive concept, the scope of which is defined in the appended claims and their equivalents.

What is claimed is:

1. A user interface apparatus which is provided to an image forming apparatus, comprising:
a user interface (UI) generation unit to generate a UI comprising an input window; and
a control unit to control the UI generation unit to change the size of the input window if the input window is activated.

2. The user interface apparatus of claim 1, wherein the control unit controls the UI generation unit to enlarge the size of the input window if a letter or a number starts being input into the input window or if the image forming apparatus enters a mode to require a letter or a number to be input into the input window.

3. The user interface apparatus of claim 1, wherein the control unit controls the UI generation unit to change the size of the letter or the number to be input into the input window according to variance in the size of the input window.

4. The user interface apparatus of claim 1, wherein the control unit controls the UI generation unit to restore the size of the input window to a default size if a preset event occurs after the letter or the number is input into the input window or if a preset period of time has passes after the letter or the number is input into the input window.

5. The user interface apparatus of claim 1, wherein the control unit changes the size of a non-input-window area and a letter or a number in the non-input-window area if the size of the input window changes.

6. The user interface apparatus of claim 1, wherein the UI generation unit generates a plurality of input windows and locates a cursor in at least one of the plurality of input windows, and
the control unit controls the UI generation unit to change the size of the input window in which the cursor is located.

7. The user interface apparatus of claim 6, wherein the control unit controls the UI generation unit to reduce the size of a first input window and enlarge the size of a second input window if the cursor moves from the first input window to the second input window among the plurality of input windows.

8. A method for providing a user interface (UI) by an image forming apparatus, the method comprising:
generating a UI comprising an input window;
activating the input window; and
changing the size of the input window.

9. The method of claim 8, wherein the size of the input window is enlarged if a letter or a number starts being input into the input window or if the image forming apparatus enters a mode to require a letter or a number to be input into the input window.

10. The method of claim 8, wherein the size of the letter or the number to be input into the input window changes according to variance in the size of the input window.

11. The method of claim 8, further comprising:
restoring the size of the input window to a default size if a preset event occurs after the letter or the number is input into the input window or if a preset period of time has passes after the letter or the number is input into the input window.

12. The method of claim 8, further comprising changing the size of a non-input-window area and a letter or a number in the non-input-window area if the size of the input window changes.

13. The method of claim 8, further comprising:
generating a plurality of input windows and locating a cursor in at least one of the plurality of input windows; and
changing the size of the input window in which the cursor is located.

14. The method of claim 13, further comprising:
reducing the size of a first input window and enlarging the size of a second input window if the cursor moves from the first input window to the second input window among the plurality of input windows.

15. A computer-readable medium containing computer-readable codes as a program to perform a user interface usable with an image forming apparatus, the method comprising:
generating a UI comprising an input window;
activating the input window; and
changing the size of the input window.

16. An image forming apparatus comprising:
a user interface apparatus including a user interface (UI) generation unit to generate a UI comprising an input window, and a control unit to control the UI generation unit to change the size of the input window if the input window is activated to receive data; and
a unit to perform an operation corresponding to the received data.

17. The apparatus of claim 16, wherein the unit comprises one of a printing unit, a copying unit, a scanning unit, and a faxing unit.

18. The apparatus of claim 16, wherein the input window is activated according to a placement of a cursor in the input window.

19. The apparatus of claim 16, wherein the size of the input window is changed with respect to a size of the UI.

20. The apparatus of claim 16, wherein the UI includes a plurality of items including an item of the input window, and the plurality of items are changed according to the change of the input window.
